(19) United States
(12) Patent Application Publication
(10) Pub. No.: US 2006/0049356 A1
(43) Pub. Date: Mar. 9, 2006

(54) Terahertz spectroscopy

(76) Inventors: Yaochun Shen, Cambridge (GB); Alexander Giles Davies, Leeds (GB); Edmund H Linfield, Cambridge (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/526,982

(22) PCT Filed: Sep. 8, 2003
(86) PCT No.: PCT/GB03/03888

§ 371 Date: May 24, 2005

(30) Foreign Application Priority Data
Sep. 6, 2002 (GB) 02200755.3

(51) Int. Cl. G01N 21/17

(52) U.S. Cl. 250/341.1

(57) ABSTRACT

A terahertz spectroscopy system comprises a tenahertz source for illuminating, in use, a sample with a pulse of radiation in the terahertz frequency range. Excitation means provides excitation energy in the form of an electromagnetic or acoustic wave during illumination of the sample by the terahertz source and a terahertz sensor receives energy from the illuminated sample. Processing means receives signals from the terahertz sensor and processes them to provide an output representative of the terahertz spectrum received by the sensor.

Over the past few years, there has been much interest in developing the technique of difference spectroscopy for the investigation of photo-biological systems. Examples of such systems include bacteriorhodopsin and rhodopsin, as well as the study of photosynthetic reaction centers in bacteria and plants. The principle behind difference spectroscopy consists of recording infrared spectra (of, for example, a protein) in two different states, before and after applying an external perturbation such as light. The difference is then calculated, and only vibrational modes that change in intensity or frequency are identified in the difference spectrum. Signals that do not originate from groups affected by the perturbation are subtracted out. This technique is particularly effective in probing minute structural differences between two states.

Light-induced difference spectroscopy (based on Fourier transform infrared (FTIR) technology) has been developed and applied successfully to investigate the structural changes associated with individual bonds of chromophores and proteins. The detection sensitivity (defined as ΔT/T, where T is the transmission coefficient) achieved in the mid-infrared frequency range is 10⁻⁵-10⁻⁶, at fixed delay and frequency, although greater sensitivity is required to apply difference spectroscopy to other important photo-biological systems. In the far-infrared (terahertz) range, however, the poor performance of FTIR spectrometers, owing to the lack of suitable sources and detectors, makes it impractical to develop an FTIR difference spectroscopy system.

Recent advances in terahertz (THz) time-domain spectroscopy have, though, stimulated interest in developing light-induced THz difference spectroscopy. The general THz frequency range is interpreted as that lying between 25 GHz to 100 THz. Key benefits of such spectroscopy include the acquisition of time-resolved data and coherent detection. These give the amplitude and phase of the THz field, rather than simply the laser intensity. The dynamic range of coherent THz detection has been reported to be 10⁵-10⁶, corresponding to an intensity range of 10¹⁰-10¹². Such a high dynamic range together with the intrinsic advantage of time resolved coherent detection make the THz time-domain system attractive for differential spectroscopy.

There has also been proposed differential THz time-domain spectroscopy for the characterization of thin dielectric films. In this approach, a mechanical shaker is used to exchange rapidly the sample of interest and a reference sample at a frequency of 20-100 Hz. The small difference between the THz pulses transmitted through the sample and reference was monitored with a lock-in amplifier. Extremely high sensitivity, of the order ΔT/T≈10⁻⁹, is apparently possible but therequirement for a mechanical shaker limits the practicality of the device and makes it difficult to control and potentially unreliable.

According to the present invention there is provided a terahertz spectroscopy system comprising:

a terahertt source for illuminating, in use, a sample with a pulse of radiation in the terahertz frequency range;

excitation means for providing excitation energy in the form of an electromagnetic or acoustic wave or altemative energy beam on a selected portion of the illuminated sample prior to or during illumination of the sample by the terahertz source;

a terahertz sensor for receiving energy from the illuminated sample; and processing means for receiving signals from the terahertz sensor and processing them to provide an output representative of the terahertz spectrum received by the sensor.

The present invention provides a highly accurate device with high resolution by provision of concentrated excitation that can select a small portion of an illuminated sample. In combination with terahertz detection this allows for differential detection for accurate measurement. It also means that complex focussing of the terahertz source to increase resolution is not necessary. The terahertz detection may be electro-optical or photoconductive.

The excitation means may be a laser and may be a low power laser. The laser may also provide the terahertz source.

Optical components may be provided in the system in order to focus the terahertz radiation onto the sample and also onto the terahertz sensor.

Means may be provided for controlling the direction of the exciting energy to scan it across the surface of the sample in use. Corresponding means may be provided to control the illumination of the terahertz radiation in order to enable scanning of this also across the sample.

There may also be provided means for focussing or localising the exciting energy in order to control its spatial resolution and hence control the overall spatial resolution of the system.

An example of the present invention will now be described with reference to the accompanying drawings, in which:

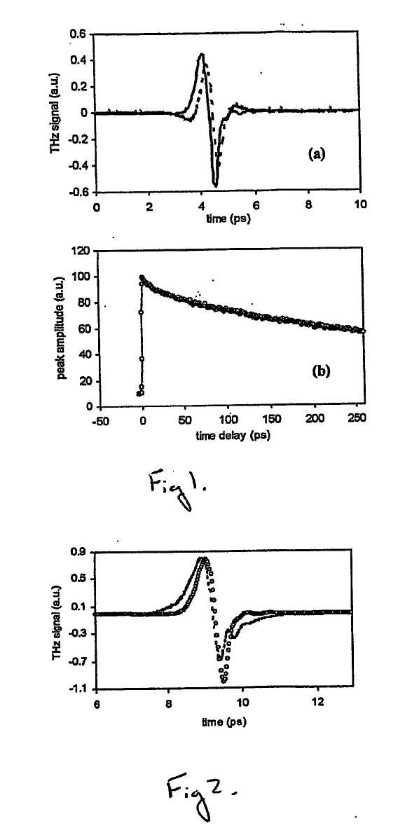

FIGS. 1a and 1b are graphs showing the output from an example system according to the present invention when measuring a semiconductor surface and an output of an example system according to the invention showing peak amplitude versus time delay;

FIG. 2 is a graph showing measured terahertz signal transients for the same semiconductor material as employed in FIG. 1 for both unexcited (open circles) and excited (lines) samples;

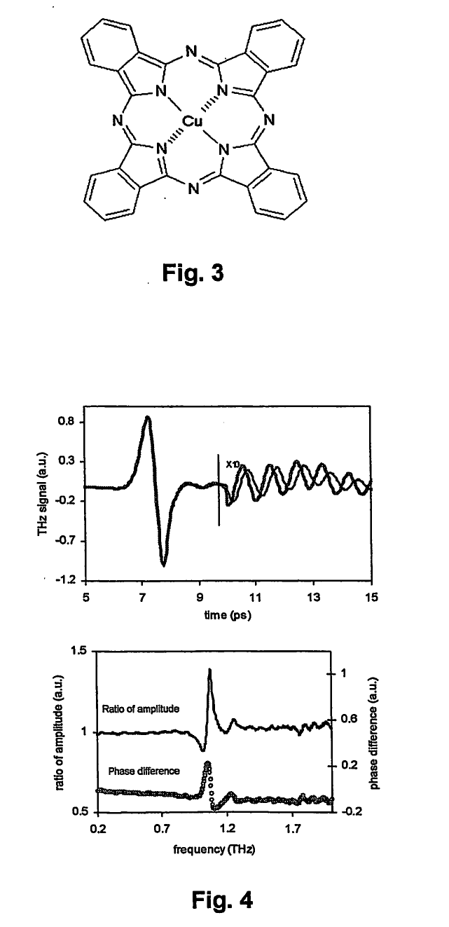

FIG. 3 is a diagram showing a molecular structure of a copper dye molecule sample employed in a measurement using an example system of the present invention;

FIG. 4 shows two graphs indicating outputs of an example system according to the present invention when measuring the sample of FIG. 3;

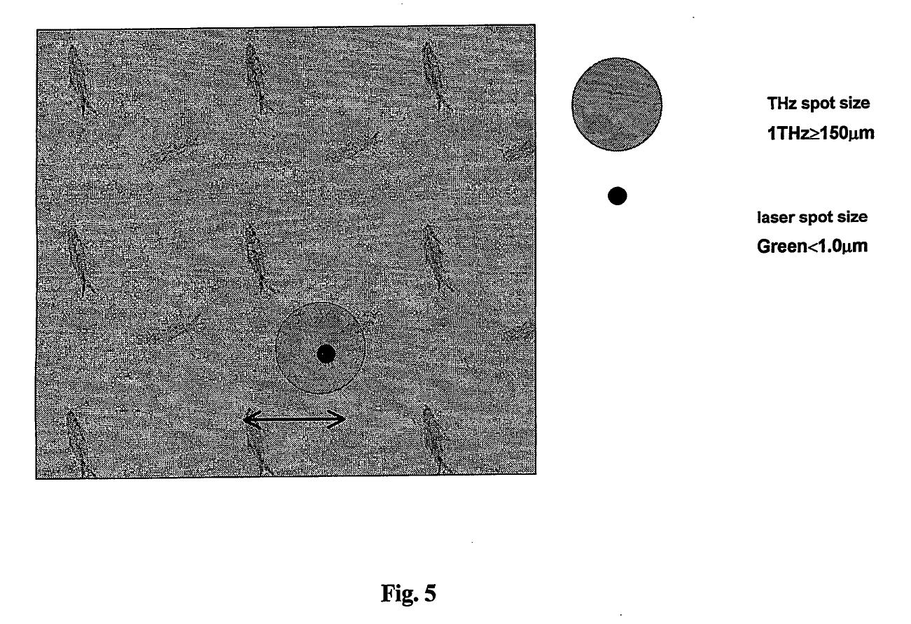

FIG. 5 is a plan view of a sample being illuminated by the system of the present invention;

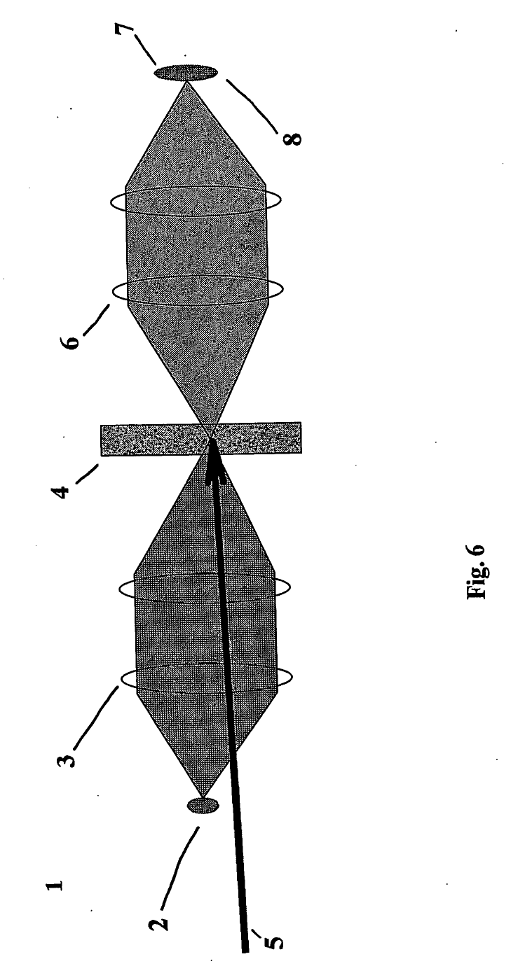

FIG. 6 is a side schematic diagram showing the system of the present invention; and

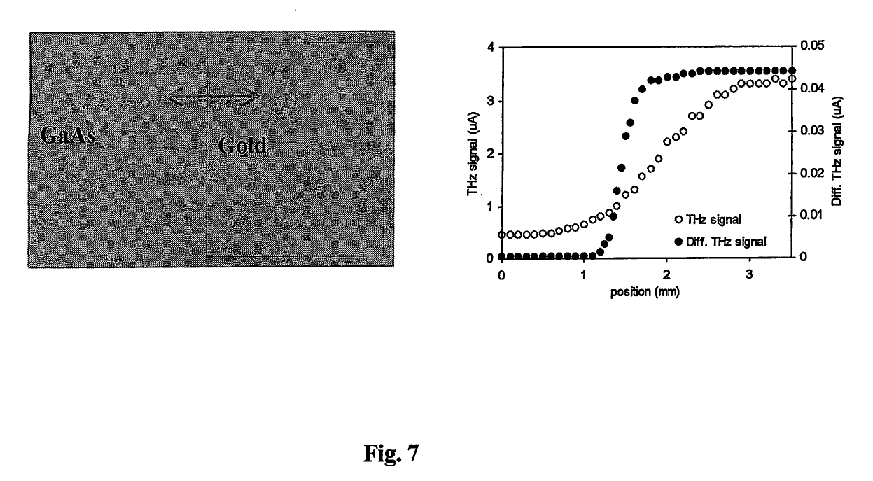

FIG. 7 shows a plan view of a semiconductor sample and an output of the system according to the present invention showing clearly the increased resolution of the system as it passes from a first to second material.

Referring now to the figures, an example system according to the present invention will be described, together with two example experiments using that system.

Referring to FIG. 6, a system 1 according to the present invention has a terahertz source 2 which is focussed through optical components 3 onto a sample 4. The sample 4 is also illuminated by an exciting energy source 5, which in this case is a pumped Ti:sapphire laser, but maybe other sources, such as Yb:Er doped fibre, Cr:USaf, Yb:silica, Nd:YLF, Nd:YAG, Yb, BOYS, etc. The exciting source 5 may alternatively be an acoustic wave source or energy beam source, such as a neutron beam. Additional optional optics 6 focus terahertz radiation passing through the sample 4 to a terahertz sensor 7 which provides an output to processing means 8. Alternabvely the terahertz radiation may be reflected from the sample and detected.

As can be seen from FIG. 5, the terahertz radiation generated by the terahertz source 2, which may be excited by the lasers, can be scanned across the surface of the sample 4 by a scanning mechanism 3 whilst the laser beam 5 is also scanned by mechanism 10 within the confines of the spot defining the terahertz radiation, such that the whole surface of the sample can be evaluated in a controlled manner.

Much of the arrangement of a spectroscopy system according to the invention is similar to that for visible-pump-THz-probe experiments. The laser 5 is provided and produces visible/near-infrared pulses of, in this example, 12 fs duration at a centre wavelength of 790 nm. The output is split into three parts: a 250 mW beam is used to excite sample 4 with a focus diameter of 300 μm at a variable time delay with respect to the THz pulse; a 250 mW beam is focussed onto the surface of a biased semi-insulating Ga As (SI-GaAs) emitter for THz generation; and the remaining 25 mW serves as the probe beam for electro-optic detection using a 1-mm-thick ZnTe crystal. Of course the sensor 7 maybe provided by alternative crystal compositions or a photoconductor.

If photoconductive antenna detection is used, current flowing in a photoconductor excited by a gating laser pulse is measured as a function of delay with respect to a terahertz pulse. The optical gated pulse illuminating the photoconductor generates electron-hole pairs in a gap of the photoconductive antenna. The terahertz electric field co-propagating in the photoconductor drives these carriers and produces a current, its magnitude being proportional to the terahertz field.

The laser energy used to excite the samples is only a few nJ, rather than the few μJ used in most pump-probe experiments leading to low energy flux on the sample. This feature has additional benefits in that low energy pulses are less likely to damage the samples under investigation, which is of a particular concern for some biomedical samples.

The light-induced THz time-domain difference spectrometer system of the invention can be operated in two ways. The first, and simplest, approach is to use the THz spectrum of the sample in its ground state (without laser excitation) as the reference, and compare this with the spectrum of the sample under laser excitation. The latter can be achieved by electrically chopping the THz beam 2 whilst maintaining constant pump laser excitation. The difference THz spectrum is then calculated in processing means, and only vibrational modes that change in intensity or frequency are detected in the difference spectrum. Signals not originating from groups affected by the laser excitation are subtracted out by the processing means 8.

In the second approach, if the photogenerated process under investigation is fast and highly reproducible, the difference THz time-domain spectrum is measured directly, with a much higher sensitivity. In this case, the pump beam 5 exciting the sample is chopped by a mechanical chopper whilst the THz beam 2 is kept constant. The idea is to monitor the small THz transmission difference between the two sample states by alternately measuring the THz transmission through the excited and unexcited sample, and monitoring the difference signal with a lock-in amplifier. Owing to the intrinsic advantage of the coherent THz generation and detection, detection levels of the order ΔT/T≈10⁻⁸ can be demonstrated, which is already 2-3 orders of magnitude better than the performance of known FTIR spectroscopy systems.

Two examples of use of the present invention will now be described to aid understanding of its benefits.

Example one, semiconductor sample. In order to evaluate the performance of the light-induced THz time-domain spectrometer of the invention, SI-GaAs and HR-silicon wafers were studied using the second approach discussed above. FIG. 1(a) shows the measured THz signal without the pump laser pulse (solid line) and the differential THz signal (dashed line) 5 ps after visible laser excitation for SI-GaAs. The differential signal has been amplified by a factor of 50 for comparison. The amplitude of the differential THz signal is less than 2% of the original THz signal because only a 2 nJ pulse was used for excitation, corresponding to an energy density of about 3 μJ/cm². The peak amplitude of the differential THz pulse was monitored as a function of time after the visible laser excitation and is plotted in FIG. 1(b). A 50 ps lifetime was calculated by fitting the experimental results.

The differential THz signal arrives at the detector about 100 fs later than the original THz signal, as shown in FIG. 1(a). This can be explained as follows. The generated THz pulse is collected and focussed onto the sample surface by two parabolic mirrors. Owing to diffraction during the THz wave propagation, the lower frequency components of the THz pulse will focus to a larger spot size at the sample surface than the higher frequency components. The visible pump laser has a spot diameter of 300 μm and only this pumped area of the sample will produce the differential THz signal. The spatial confinement of the differential THz pulse in the pump area thus acts as a spectral filter, shifting the frequency distribution of the transmitted THz pulse towards higher frequency. This reshapes the THz waveform and, owing to the normal dispersion, slows the THz pulse down so that it arrives at a later time. The shape and peak position of the differential THz signal can be well simulated by applying a high-pass digital filter to the original THz signal, confirming that the effect of a spectral filter is to cause the later arrival of the differential THz pulse.

In contrast to our observations here, Schall et al. observed the THz pulse to arrive earlier when transmitted through an optically excited SI-GaAs layer. This is a result of the different experimental arrangement used. It has been known to measure the THz pulses transmitted through an unexcited and a continuously excited GaAs layer. In this case, the frequency-dependent transmission and phase shift at the air-GaAs (excited) interface has a substantial contribution to the observed earlier arrival of the THz pulse. Indeed the earlier arrival of the THz pulse for excited HR-silicon wafers is shown in FIG. 2. The open circles on FIG. 2 define the THz transient from the unexcited HR silicon layer. The dashed line is the THz transient from the excited layer, which has been multiplied by a factor of 2.5 for comparison. For a silicon wafer the lifetime of the photo-generated carriers is much longer than the time interval between two successive optical pulses (12 ns). A much larger differential THz signal is observed owing to the accumulation of photo-generated carriers in the silicon. Considering that HR-silicon is widely used in THz time-domain spectroscopy experiments, care must be taken to avoid the frequency-dependence of the transmission and phase shift caused by long-lived photo-generated carriers. Note that the effective spot size of the pump beam on the sample surface in thts case is much larger owing to the diffusion of the photo-generated electrons.

In summary, for GaAs wafers, we directly measured the differential THz signal resulting from optical excitation. The differential signal is only a small fraction (1-2%) of the original THz signal, therefore, the contribution from the frequency-dependent transmission and phase shift at the interface is much smaller for GaAs than HR-silicon. The main contribution to the differential THz signal is thus from the spectral filter owing to the spatial confinement of the THz pulse in the pump area.

Example two, copper phthalocyanine pellet. Phthalocyanines are important dye molecules with excellent light harvesting capabilities, and their biomedical applications have been extensively investigated. The molecular structure of copper phthalocyanine (CuPc) is shown in FIG. 3. The optical absorption of CuPc peaks at 678 nm and overlaps with the spectrum of the pump laser pulse (centre wavelength 790 nm, bandwidth 100 nm). FIG. 4 shows the THz transient transmitted through a

CuPc pellet measured in the presence and absence of visible laser excitation. In FIG. 4(a) the solid line is the THz transient in the presence of visible laser excitation, while the open circles represent the THz transient in the absence of visible laser excitation. Both transients are multiplied by a factor of ten for times greater than 10 ps. The main THz pulses measured with and without laser excitation are almost identical, suggesting that most frequency components in the absorption spectrum do not change under laser excitation. However, the smaller amplitude ripples after the main pulse in the time domain are different, indicating that some absorption features are changed by the laser excitation. The Fourier transforms of the measured THz transients are calculated and the ratio of their amplitudes is plotted in FIG. 4(b), togetherwith the relative phase difference. We observe features at 1.08 THz and 1.26 THz. This result represents evidence of a light-induced vibrational mode change in the THz frequency range.

We do not believe that the observed change results from the mobile electrons, which is the main cause for the differential THz signal in semiconductors. Instead, the observed peak is due to the change in the environment surrounding the vibrational modes. The energy associated with vibration modes in the THz frequency range is about 4 meV, corresponding to a temperature difference (kT) of 47° C. Therefore a few degrees change in temperature is sufficient to cause substantial change in either the intensity or the frequency of the THz vibrational modes.

The present invention has significant implications for THz medical imaging. The present invention can be used in reflection mode in medical applications. The resolution of a THz imaging system is ultimately limited by the wavelength of the THz wave and although near field optics can be used to obtain higher resolution images, this can not be applied to in vivo THz imaging beneath, for example, the surface of skin. As is provided by the present invention, the effective spot size of a THz pulse can be spatially confined to the pump area of a sample, which is determined by the focussed size of the visible pump laser beam. Therefore the resolution of a differential THz imaging system is ultimately limited by the spot size of the visible pump beam rather than the THz wavelength. As can be seen from FIG. 7, the resolution of the device of the invention is significantly greater when compared to known devices.

1. A terahertz spectroscopy system comprising:
a terahertz source for illuminating, in use, a sample with a pulse of radiation in the terahertz frequency range;
excitation means for providing excitation energy in the form of a beam on a selected portion of the illuminated sample prior to or during illumination of the sample by the terahertz source;
a terahertz sensor for receiving energy from the illuminated sample; and
processing means for receiving signals from the terahertz sensor and processing them to provide an output representative of the terahertz spectrum Preceived by the sensor.

2. The system of claim 1, wherein the excitation means is a laser.

3. The system of claim 2, wherein the laser also provides the excitation for the terahertz source.

4. The system of claim 1, wherein the excitation means provides excitation energy in the form of a neutron beam.

5. The system of claim 1, wherein the excitation means provides an acoustic wave beam

6. The system of claim 1, wherein optical components are provided in the system in order to focus the terahertz radiation onto the sample and onto the terahertz sensor.

7. The system of claim 1, wherein means are provided for controlling the direction of the exciting energy to scan it across the surface of the sample in use.

8. The system of claim 7, wherein means are provided to control the illumination of the terahertz radiation in order to enable scanning of this across the sample.

9. The system of claim 1, wherein there is provided means for focusing or localizing the excitation energy in order to control its spatial resolution and hence control the overall spatial resolution of the system.

10. The system of claim 1, wherein the terahertz sensor is an electro optic sensor.

11. The system of claim 10, wherein the sensor is an EOS crystal.

12. The system of claim 1, wherein the terahertz sensor is a photoconductive sensor.

13. The system of claim 1, wherein the processing means is arranged to control the Terahertz source and excitation means in order to control illumination of the sample.

14. The system of claim 13, wherein the processing means is arranged to control illumination of the sample such that a reference measurement is taken without excitation energy on the sample and is also arranged to provide a differential signal based upon a comparison between the reference measurement and other measurements.
